(19) United States
(12) Patent Application Publication
(10) Pub. No.: US 2014/0345340 A1
(43) Pub. Date: Nov. 27, 2014

(54) VARIABLE RATE CHEMICAL MANAGEMENT METHODS FOR AGRICULTURAL LANDSCAPES USING MULTIFORM GROWTH RESPONSE FUNCTION

(71) Applicant: Kyle H. Holland, Lincoln, NE (US)

(72) Inventor: Kyle H. Holland, Lincoln, NE (US)

(21) Appl. No.: 13/898,599

(22) Filed: May 21, 2013

(51) Int. Cl. C05C 11/00

(52) U.S. Cl. CPC C05C 11/00
USPC 71/1

(57) ABSTRACT

A method for applying agrochemicals within a geographical area, the method includes determining identify of a first hybrid or variety within the geographical area, determining identify of a second hybrid or variety within the geographical area, and applying agrochemicals to the geographical area using a variable rate controller based on the identity of the first hybrid or variety and the identity of the second hybrid or variety and wherein the variable rate controller is configured to apply the agrochemicals using a first model for the first hybrid or variety within the geographical area and a second model for the second hybrid or variety within the geographical area.

### CROSS REFERENCE TO RELATED U.S. APPLICATIONS

This application is related to commonly owned U.S. patent application Ser. No. ______, by Kyle Holland, filed on May 21, 2013, entitled “VARIABLE RATE CHEMICAL MANAGEMENT FOR AGRICULTURAL LANDSCAPES USING MULTIFORM GROWTH RESPONSE FUNCTION” with attorney docket number P10630US00.

### FIELD OF THE INVENTION

The present invention relates to variable rate chemical management for agricultural landscapes. More particularly, but not exclusively, the present invention relates to real-time sensor based application of agrochemicals.

### BACKGROUND OF THE ART

Various methodologies are available to crop producers which allow them to apply agrochemicals. Some methodologies use real-time active crop sensors for variable rate control of agrochemicals. Often times the agrochemical application model has limited or no flexibility to be modified during use in a field. Current real-time sensor-based applicators generally use only a single sensor for determining an agrochemical application rate for an agricultural landscape. This limits the applicator system's ability to respond to other geospatial features of the landscape. Additionally, the applicator can only apply based on plant vegetation information which may or may not fully describe the plant's growing conditions.

What is needed are systems and methods that incorporate real-time adaptable plant growth response models and/or multiple sensing methods which are simple and convenient for agricultural producers to use while optimizing the application of agrochemicals in acceptable and desirable manners.

### SUMMARY OF THE INVENTION

Therefore, it is a primary object, feature, or advantage of the present invention to improve over the state of the art.

It is a further object, feature, or advantage of the present invention to provide for mathematical methods and models to be used in conjunction with the application of agrochemicals which use real-time sensors to assist in the application of the agrochemicals.

It is a further object, feature, or advantage of the present invention to provide for mathematical methods and models to be used in conjunction with the application of agrochemicals which use map based tools to assist in the application of the agrochemicals.

It is a further object, feature, or advantage of the present invention to provide for methods and systems for application of agrochemicals which use real-time sensors to assist in the application of the agrochemicals.

It is a still further object, feature, or advantage of the present invention to provide for methods and systems for application of agrochemicals which do not require the use of crop reference strips or regions for calibration purposes.

Another object, feature, or advantage of the present invention is to provide for methods and systems for applications of agrochemicals which allow for users to select the methodology or algorithms to be used.

Yet another object, feature, or advantage of the present invention is to allow a crop producer to variably control rate of application of agrochemicals without driving through at least a portion of the field for calibration purposes.

A still further object, feature, or advantage of the present invention is to use adaptive algorithms for variably controlling the rate of application of agrochemicals within a field.

Yet another object, feature, or advantage of the present invention is to variably control application of more than one agrochemical at a time.

A still further object, feature, or advantage of the present invention is to record and map the application of agrochemicals within a field.

Yet another object, feature, or advantage of the present invention is to permit use of GPS data to assist in the application of agrochemicals within a field.

A further object, feature, or advantage of the present invention is to provide for variable rate control which does not require the use of GPS data.

A still further object, feature, or advantage of the present invention is to provide for variable rate control methodologies which may be used with remote sensing as well as real-time active sensors.

Yet another object, feature, or advantage of the present invention is to use aerial or satellite imagery data to assist in the application of agrochemicals, using adaptive algorithms, within a field.

Yet another object, feature, or advantage of the present invention is to use aerial or satellite imagery data to assist in the application of agrochemicals, using adaptive algorithms, to different areas of the field containing different hybrids or varieties of crop having different nutrient utilization characteristics within a field.

Yet another object, feature, or advantage of the present invention is to use aerial or satellite imagery data to assist in the application of agrochemicals, using adaptive algorithms, to different areas of the field containing different hybrids or varieties of crop having different nutrient utilization characteristics planted in areas of the field with differing soil fertility properties within a field.

One or more of these and/or other objects, features, or advantages will become apparent from the specification and claims that follow. No single embodiment of the present invention need exhibit each or any of the objects, features, or advantages. The present invention is not to be limited by or to these objects, features, or advantages.

Various methods are provided for practicing sensor-based precision farming techniques pertaining to the application of materials such as seeds, fertilizer, pesticides, herbicides or other agricultural substances. Multivariate growth response models may be used to optimize application of an agrochemical and thereby enhances crop production over all areas of a field. The methods disclosed hereafter include variable-rate agrochemical application methods that utilize multivariate growth response models to optimize chemical application to a plant based on geospatial, geophysical and biophysical properties of the landscape, soil and plant, respectively. Information collected by the measurement instrumentation may be processed so as to produce a normalized biomass (growth) response function for the entire field. This function can then be utilized in conjunction with a grower's conventional farming practice to optimize application of an agrochemical. Additionally, the methodologies disclosed hereafter are not limited to real-time active sensors but may also be applied to other remote sensing technologies such as aerial and satellite imaging.

According to one aspect of the present invention, an apparatus for applying agrochemicals within a geographical area is provided. The apparatus includes a dispensing system configured for dispensing the agrochemicals and a variable rate controller operatively connected to the dispensing system and configured to control dispensement of agrochemicals from the dispensing system. The variable rate controller is programmed with a plant growth response function that utilizes multiple sensor input parameters. The plant growth response function may take into account genetic information associated with a particular hybrid or variety of the plant.

According to another aspect of the present invention, an apparatus for applying agrochemicals within a geographical area is provided. The apparatus includes a dispensing system configured for dispensing the agrochemicals and a variable rate controller operatively connected to the dispensing system and configured to control dispensement of agrochemicals from the dispensing system. A sensor, or plurality of sensors, is connected to variable rate controller is programmed with a plant growth response function that utilizes multiple sensor input parameters. The plant growth response function may take into account genetic information associated with a particular hybrid or variety of the plant.

According to one aspect of the present invention, an apparatus for applying agrochemicals within a geographical area is provided. The apparatus includes a dispensing system configured for dispensing the agrochemicals and a variable rate controller operatively connected to the dispensing system and configured to control dispensement of agrochemicals from the dispensing system. The variable rate controller is programmed with planting zone map for multiple hybrids or plant varieties, each hybrid having its own plant growth response function that utilizes one or multiple sensor input parameters. The different plant growth response function may take into account genetic information associated with the particular hybrids or varieties of plants.

According to another aspect of the present invention, an apparatus for applying agrochemicals within a geographical area is provided. The apparatus includes a dispensing system configured for dispensing the agrochemicals and a variable rate controller operatively connected to the dispensing system and configured to control dispensement of agrochemicals from the dispensing system. A sensor, or plurality of sensors, is connected to variable rate controller with said controller programmed with a planting zone map for multiple hybrids or plant varieties, each hybrid having its own plant growth response function programmed into the sensor or plurality sensors that utilizes one or multiple sensor input parameters.

According to one aspect of the present invention, an apparatus for applying agrochemicals within a geographical area is provided. The apparatus includes a dispensing system configured for dispensing the agrochemicals and a variable rate controller operatively connected to the dispensing system and configured to control dispensement of agrochemicals from the dispensing system. The variable rate controller is programmed with a plant growth response function that utilizes multiple sensor input parameters and may take into account characteristics of different hybrids or varieties.

According to another aspect of the present invention, a method for applying agrochemicals within a geographical area is provided. The method includes acquiring a growth stage appropriate plug value for an initial calibration, using the growth state appropriate plug value in the initial calibration, and applying agrochemicals to the geographical area according to the initial calibration. The initial calibration may take into account the identity of the different hybrids or varieties and the genetics of the different hybrids or varieties.

According to another aspect of the present invention, a method for calibrating a system for treating plants growing in a geographical area is provided. The method may include acquiring a growth stage appropriate plug value for an initial calibration, passing an optical sensor over a part of the geographical area, measuring with the sensor a plant growth parameter at a plurality of locations within the geographical area, and analyzing the growth parameter measurements to generate a normalized response function for the geographical area. Multiple plug values may be used with each representing the optimal plug value for a given hybrid or variety of crop. For example, a field planted with two hybrids would have a plug value assigned to hybrid 1 and another plug value for hybrid 2. The plug values will most likely be different but under some circumstances may be the same.

According to another aspect, various means may be included such as means for providing spatially variable vegetation index data may be includes, means for receiving optimum or economically optimum agrochemical rate data, and means for applying an agrochemical recommendation model to the spatially variable vegetation index data and the optimum or economically optimum agrochemical rate data to provide a recommended rate for treatment of crops.

According to another aspect, a system for treatment of crops may include an agricultural machine, an intelligent control operatively connected the agricultural machine, and an agrochemical recommendation model stored on a memory associated with the intelligent control. The agrochemical recommendation model provides for determining a recommended rate for treatment of crops using spatially variable vegetation index data and optimum or economically optimum agrochemical rate data.

According to another aspect of the present invention, a method for treatment of a crop includes receiving optimum or economically optimum agrochemical rate data, receiving spatially variable vegetation index data, receiving growth related data as determined from climate information, applying an agrochemical recommendation model to determine an agrochemical recommendation for application of an agrochemical, and applying the agrochemical to the crop.

According to another aspect of the present invention, a method for treatment of a crop includes receiving optimum or economically optimum agrochemical rate data, receiving spatially variable vegetation index data, receiving crop specific genetic data related to the crops nutrient and/or growth needs, applying an agrochemical recommendation model to determine an agrochemical recommendation for application of an agrochemical, and applying the agrochemical to the crop.

According to another aspect, an apparatus is configured for dispensing nutrients. The apparatus may include a dispensing system configured for dispensing the nutrients for a particular plant hybrid or plant variety and a variable rate controller operatively connected to the dispensing system and configured to control dispensement of the nutrients from the dispensing system. The variable rate controller is programmed to use a plant growth response function for the particular plant hybrid or plant variety and adjust the dispensement of the nutrients from the dispensing system based on the plant growth response function. The variable rate controller is further programmed to use a predetermined plug value for the particular plant hybrid or plant variety for initial calibration.

According to another aspect of the present invention, an apparatus is configured for dispensing nutrients. The apparatus may include a dispensing system configured for dispensing the nutrients for a plurality of different plant hybrids or plant varieties, a variable rate controller operatively connected to the dispensing system and configured to control dispensement of the nutrients from the dispensing system, and at least one sensor operatively connected to the variable rate controller and adapted to measure a plant growth parameter. The variable rate controller is programmed to associate each of the plant hybrids or plant varieties with one of a set of plant growth response functions and adjust the dispensement of the nutrients from the dispensing system based on the plant growth parameter and the plant growth response function for a selected one of the plurality of different plant hybrids or plant varieties.

According to another aspect, an apparatus is configured for dispensing nutrients. The apparatus includes a dispensing system configured for dispensing the nutrients for both a first type and a second type of plant hybrid or plant variety, and a variable rate controller operatively connected to the dispensing system and configured to control dispensement of the nutrients from the dispensing system. The variable rate controller is programmed to use a first plant growth response function for the first type and a second plant growth response function for the second type and adjust the dispensement of the nutrients from the dispensing system using the first plant growth response function and the second plant growth response function. Both the first type and the second type of plant hybrid or plant variety may be planted within a single field. The variable rate controller may be programmed to use the first plant growth response function for varying application of the nutrients where the first type of plant hybrid or plant variety are planted within the field and to use the second plant growth response function for varying application of the nutrients where the second type of plant hybrid or plant variety are planted within the field.

According to another aspect, an apparatus is configured for dispensing agrochemicals, the apparatus includes a dispensing system configured for dispensing the nutrients and a variable rate controller operatively connected to the dispensing system and configured to control dispensement of the nutrients from the dispensing system. The variable rate controller may be programmed to maintain a plurality of different plant growth models and to select between the different plant growth models. A first of the plurality of different plant growth models may be associated with a first type of plant hybrid or plant variety and a second of the plurality of different plant growth models may be associated with a second type of plant hybrid or variety.

According to another aspect, a method for applying agrochemicals within a geographical area is provided. The method includes determining identify of a first hybrid or variety within the geographical area, determining identify of a second hybrid or variety within the geographical area, and applying agrochemicals to the geographical area using a variable rate controller based on the identity of the first hybrid or variety and the identity of the second hybrid or variety and wherein the variable rate controller is configured to apply the agrochemicals using a first model for the first hybrid or variety within the geographical area and a second model for the second hybrid or variety within the geographical area. The variable rate controller may be further configured to use for initial calibration a first growth stage appropriate plug value for the first hybrid or variety within the geographical area and a second growth stage appropriate plug value for the second hybrid or variety within the geographical area. The variable rate controller may be further configured to parameterize the first model for the first hybrid or variety and the second model for the second hybrid or variety with plant growth parameters. The plant growth parameters may be obtained using one or more sensors. The one or more sensors may be optical sensors. The plant growth parameters may be obtained from aerial imaging or satellite imaging. The agrochemical uses may be used to active or suppress expression of a genetic trait.

According to another aspect, a method for applying agrochemicals within a geographical area is provided. The method includes maintaining a first vegetative index using a variable rate controller, the first vegetative index associated with a first plant type. The method further includes maintaining a second vegetative index using the variable rate controller, the second vegetative index associated with a second plant type. The method further includes applying the agrochemicals to the geographical area using the variable rate controller, wherein the variable rate controller uses the first vegetative index in determining application rates for the first plant type and the second vegetative index in determining application rates for the second plant type. The method may further include sensing plant growth parameters using an optical sensor and using the plant growth parameters in the first vegetative index and sensing plant growth parameters using an optical sensor and using the plant growth parameters in the second vegetative index. The plant growth parameters may be sensed using satellite imaging, aerial imaging, on-board sensing, or a combination of methods.

According to another aspect, a method for applying agrochemicals within a geographical area may be provided. The method may include acquiring a growth stage appropriate plug value for an initial calibration at least partially based on genetic information for a plant variety or plant hybrid, using the growth state appropriate plug value in the initial calibration, and applying agrochemicals to the geographical area according to the initial calibration.

### BRIEF DESCRIPTION OF THE DRAWINGS

FIGS. 1A-1K illustrates various systems which include a variable rate controller.

FIG. 2 illustrates a generalized growth response curve.

FIG. 3 shows a field planted with multiple hybrids for which nutrients may be applied using the variable rate controller.

FIG. 4 illustrates a system with the variable rate applicator.

FIG. 5 illustrates one example of a system where a dispensing system includes a first nutrient flow system for providing nutrients according to a first nutrient application rate and a second nutrient flow system for providing nutrients according to a second nutrient application rate to allow for more than one nutrient to be applied individually or as a mix.

### DETAILED DESCRIPTION OF THE PREFERRED EMBODIMENT

### Overview

Variable rate application (VRA) of agrochemicals is an important in various types of crop production. The use of VRA is advantageous because it reduces the amount of unnecessary application of agrochemicals, reduces the likelihood of under application of agrochemicals and thus there are economic as well as environmental advantages to using variable rate application of agrochemicals instead of a fixed rate. The various methods, apparatus, and systems of the present invention allow for effective application of agrochemicals in a manner that is simple for crop producers to implement.

Moreover, a number of the methods, apparatus, and systems described herein may take advantage of the specific identity of different hybrids or varieties of plants and information associated with these hybrids or varieties either for calibration purposes, in the growth response functions or otherwise in models or algorithms such as those used by the variable rate controller. Where multiple types of plants are within the same field, real-time statistical information based on sensor readings may be maintained separately for each of the types of plants. In addition, different types of nutrients or different mixes of nutrients may be applied. In addition, agrochemicals which are used for genetic switching may be applied to turn expression of different genetic traits on or off.

### Configurations Using Variable Rate Controller

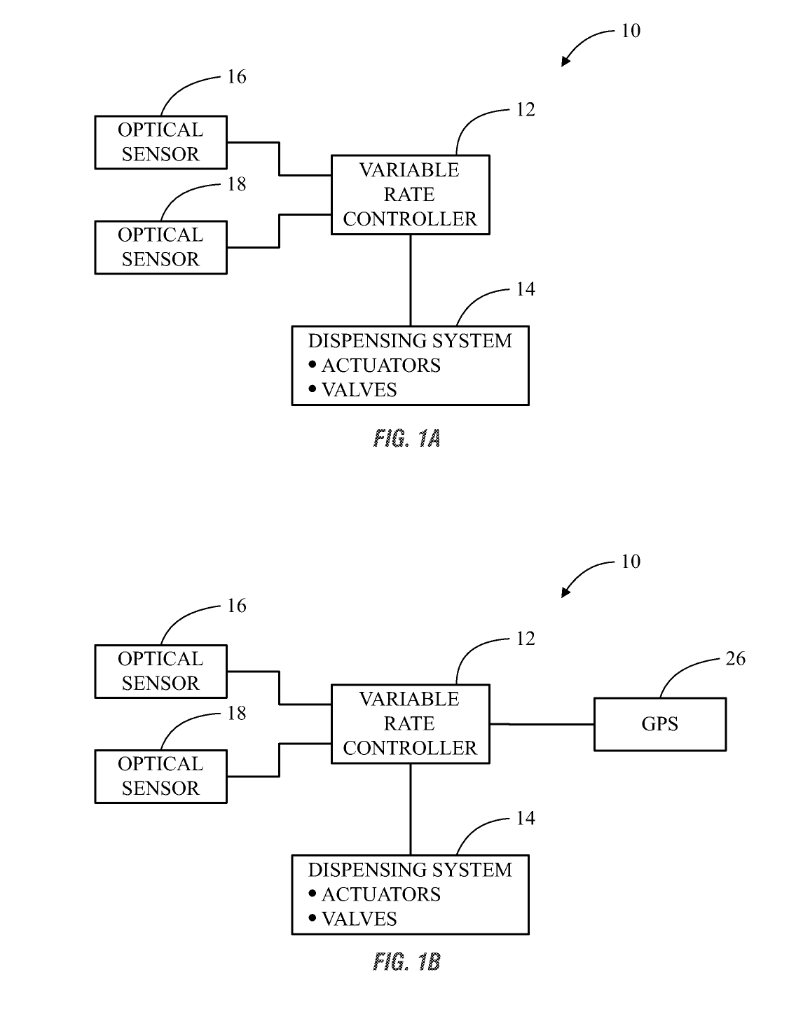

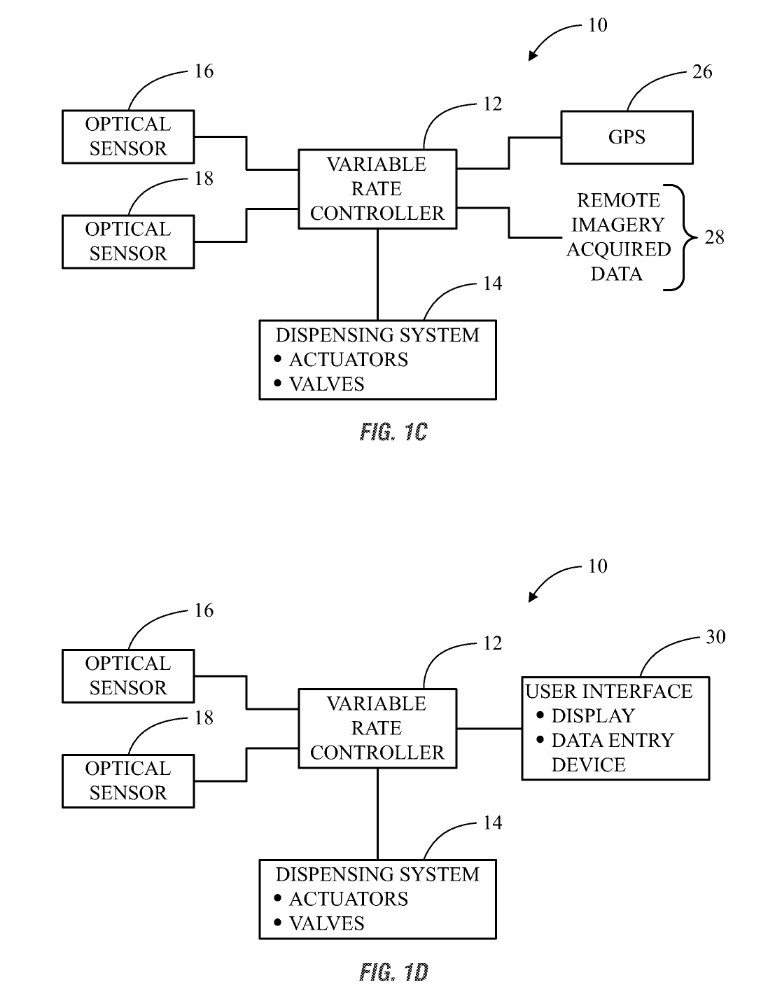

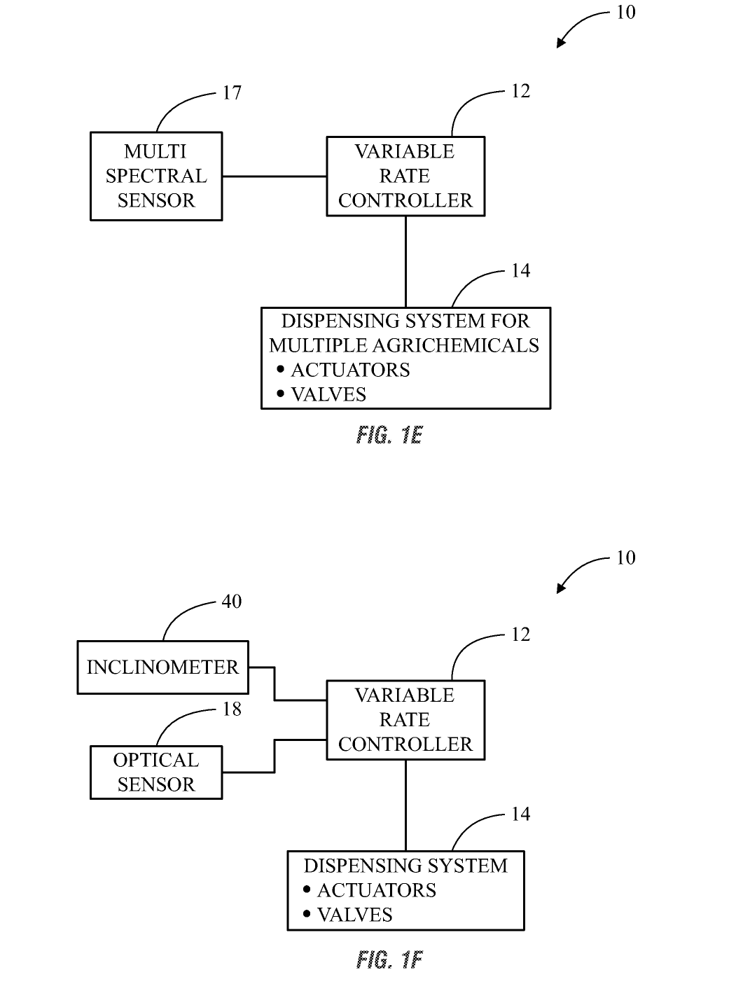

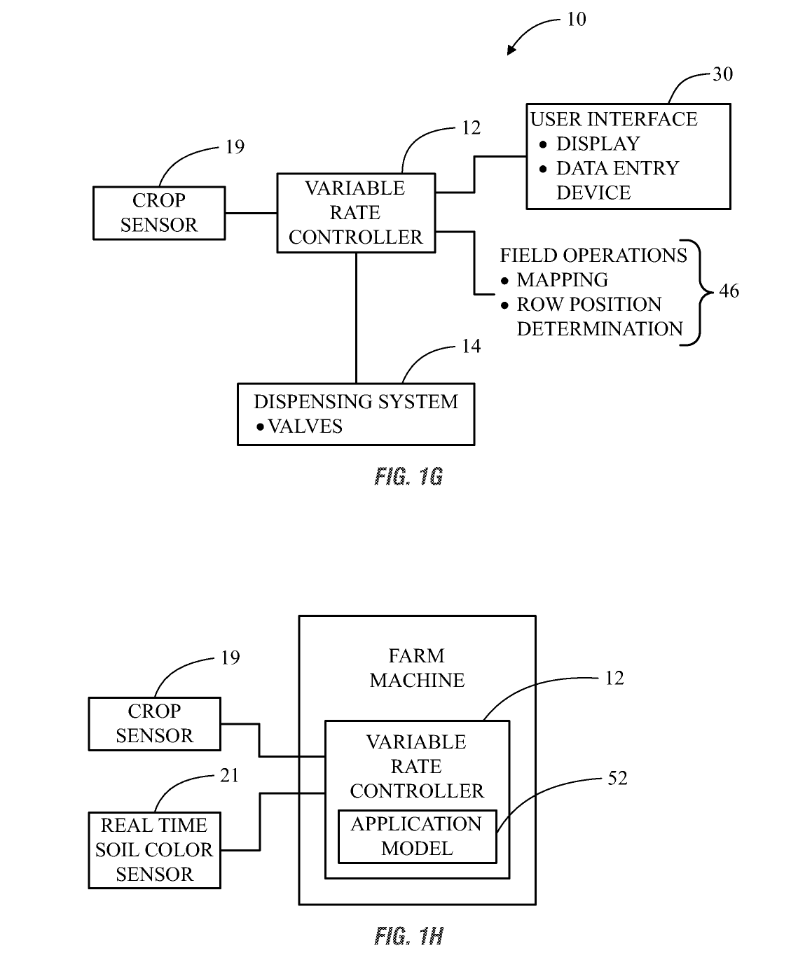

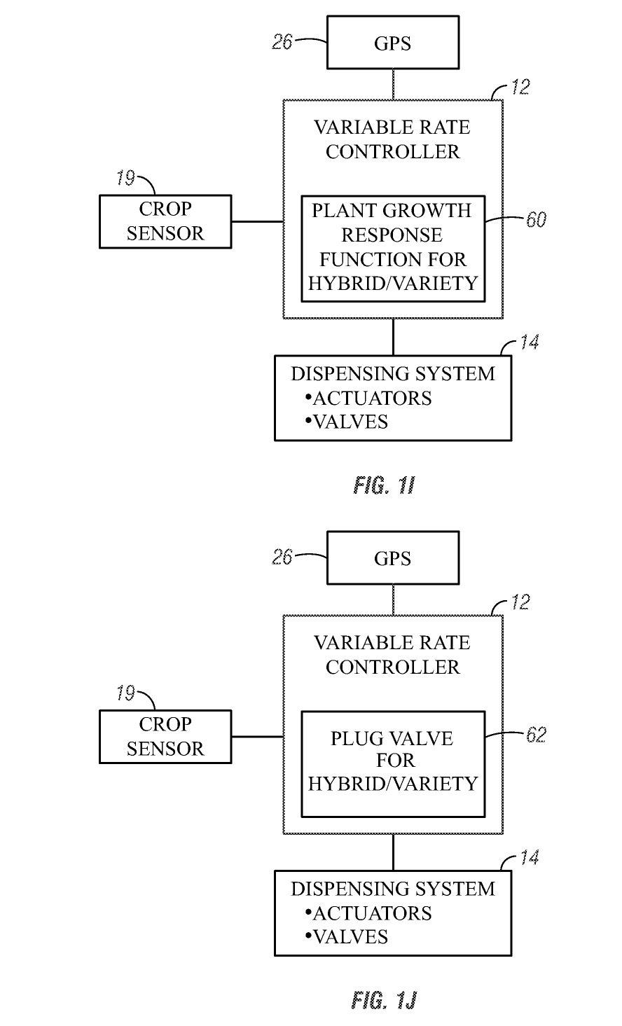

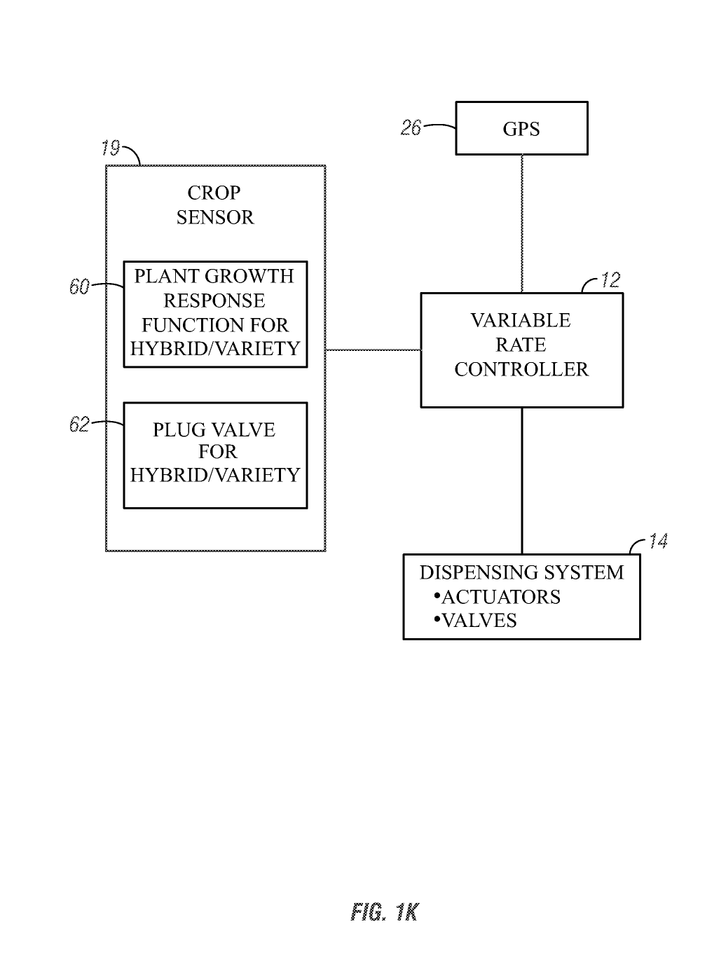

FIG. 1A to FIG. 1K illustrate different embodiments of an apparatus of the present invention. It is to be understood that no single embodiment need include all of the components shown in any of these figures. It is to be further understood that the present invention allows for components from different figures to be combined in a particular embodiment. It is to be understood that the variable rate controller shown in the different figures is configured according to various ways described later herein.

In FIG. 1A a system 10 includes a variable rate controller 12. A dispensing system 14 is operatively connected to the variable rate controller 12 and the variable rate controller 12 is configured to control the dispensing system 14. The dispensing system 14 is configured to dispense an agrochemical and may use actuators, valves, or other components to do so. Also in system 10, an optical sensor 16 and an optical sensor 18 are operatively connected to the variable rate controller 12. Although two optical sensors are shown, the present invention contemplates more or fewer sensors being used. The variable rate controller 12 receives a plug value. The plug value may be hard coded, user specified, or otherwise determined. The plug value is used in at least initial calibration of the system. The present invention contemplates that the system does not need further calibrations from a user after the initial calibration and can adjust based on measurements using the optical sensors 16, 18. The optical sensor 16 may be used for sensing plant growth parameters and the optical sensor 18 may be used for sensing soil color parameters. Of course, different configurations of sensors may be used.

Note that in such an embodiment, a user need only provide the initial calibration or information to be used in determining the initial calibration. There is no need for calibrating to test strips or regions.

In FIG. 1B, a GPS receiver 26 is operatively connected to the variable rate controller to provide geoposition information. The variable rate controller may use information from the GPS 26 in an algorithm to assist in determining application of agrochemicals. For example, there may less application of agrochemicals at locations within a field having a low altitude as various models for determining application rate may take into account movement of agrochemicals due to water movement.

In FIG. 1C, remote imagery acquired data 28 is provided to the variable rate controller 12. The present invention contemplates that instead of or in addition to using optical sensors or other crop sensors for sensing vegetative state of a crop, this information may be acquired from remote sensing data.

In FIG. 1D, a user interface 30 is operatively connected to the variable rate controller 12. The user interface 30 may include a display and a data entry device. The user interface 30 may be used by a crop producer or other user to specify a particular algorithm to use or to input plug values.

In FIG. 1E, a multispectral sensor 17 is operatively connected to the variable rate controller 12. In this embodiment, the dispensing system 14 may also be configured to dispense multiple types of agrochemicals.

In FIG. 1F, an inclinometer 40 is operatively connected to the variable rate controller 12. In this embodiment the variable rate controller 12 uses an algorithm which is configured to take into account incline data when calculating application rates. In such an embodiment GPS altitude data need not be used. In some embodiments, the GPS and inclinometer may be used in tandem to better describe the topology of the field when applying agrochemicals or defining soil zones.

In FIG. 1G, a crop sensor 19 is operatively connected to the variable rate controller 12. The crop sensor may be an optical sensor or other type of sensor. Also shown in FIG. 1G, the variable rate controller 12 may determine additional field operations in addition to dispensing rate. These may include mapping of the application of agrochemicals, row position determination, or other types of field operations.

In FIG. 1H, the variable rate controller 12 is shown as part of a farm machine. An application model 52 is stored on a machine readable storage medium associated with the variable rate controller 12. A crop sensor 19 and a real-time soil color sensor 21 are operatively connected to the variable rate controller 12.

In FIG. 1I, the variable rate controller is shown as including one or more plant growth response functions for a hybrid or variety 60. The response function(s) may be stored on a machine readable storage media of the variable rate controller. A GPS 26 is also shown which is operatively connected to the variable rate controller 12. Geospatial information from the GPS 26 may be used by the variable rate controller to determine the identity of plants or for other purposes.

In FIG. 1J, the variable rate controller is shown to include one or more plug values for hybrids or varieties 62. The plug values may be used for initial calibration as will be discussed in additional detail. The plug value(s) may be stored on a machine readable storage media such as a memory associated with the variable rate controller. Geospatial information from the GPS 26 may be used by the variable rate controller to determine the identity of plants or for other purposes.

In FIG. 1K, the variable rate controller, instead of storing plug values 62 and plant growth functions 60 within the variable rate controller, this information may be stored within a crop sensor on a machine readable storage media such as a memory associated with the variable rate controller.

From these examples, it should be apparent that the present invention provides for variable application of agrochemicals to be performed in various ways using different types of sensors and different types of algorithms or models.

### Agrochemical Management

A primary agrochemical requiring intensive management for numerous crops is N fertilizer. For purposes of illustration, we will describe our method utilizing N fertilizer as the managed agrochemical, however, it will be apparent to those skilled in the art that the principles described for fertilizer application can be applied to other agrochemicals or materials. It should also be understood that sometimes the term “nutrient” is used to describe the use of an agrochemical regardless of the function of the agrochemical.

Regarding the background science behind crop N status monitoring, it has been shown that the positive relationship between leaf greenness and crop nitrogen (N) status will allow the determination crop N requirements based on reflectance data collected from the crop canopy and leaves. Plants with increased levels of N typically have more chlorophyll and greater rates of photosynthesis. Hence, plants that appear a darker green are perceived to be healthier than N deficient plants. Chlorophyll in leaves absorbs strongly in the blue and red regions of the spectrum (460 nm and 670 nm) and reflects/transmits light in the green region (550 nm). Spectroradiometers have been used to characterize the differences in light reflected from corn canopies receiving different N treatments and to show a strong relationship between green light (550 nm) and fertilizer N rate. In addition, green light reflectance from corn during the late milk stage (R4 to R5) has been shown to be highly correlated with grain yield (r²=0.98, ten N rates for one hybrid). As a result, it is the relationship between leaf greenness (reflected green light) and chlorophyll content (absorbance) which makes it possible to remotely sense or measure leaf greenness and obtain an indication of chlorophyll concentration and plant N status.

Adoption of automated N management practices will require methodologies that impact their current farming practices minimally. Recently there has been a trend in the United States by growers to apply nitrogen via split application, that is, some of the N is applied at planting time and the remainder is applied during the growing season when the crop is most responsive to nutrient. In other situations, N is applied in multiple doses during the growing season such as in European wheat and barley crops. Here, N in these cropping systems is applied at regular intervals to achieve certain biomass goals. Both split and dosage application farming practices can benefit from the agrochemical management methodology presented herein. Cotton is another crop that will benefit from this method. Both growth regulators and defoliants are applied in-season on cotton crops. With application of growth regulators, the goal is to achieve a uniform biomass throughout a field and use of a real-time sensing system controlled with the application methodology presented here will greatly benefit cotton growers.

In the most general sense, the real-time non-reference strip variable rate application equation can be defined as follows:

S_{APP}=k·G·ƒ(α) (1)

Where S_{APP} is the desired real-time rate of application for the agrochemical,

G is the managed agrochemical dosage constant or growth response constant,

ƒ(α) is the general biomass sensitivity function or growth function,

k is a zone factor scalar (0<k<2), and

α is the normalized biomass sensitivity variable.

The functional form of the real-time eq. 1 allows a grower to set a typical in-season application rate for his agrochemical S_{App}. This may be a standard side-dress rate or some other split application or dosage rate. Modification of this in-season rate due to crop variability is performed via the sensor-controlled term, G·ƒ(α). Because soil types and field conditions across an agricultural landscape can vary substantially, zone factor k has been included in eq. 1 to allow for spatial scaling of the rate equation. For example, consider a corn field. In some soil regions of the field, soil fertility may be very low and no matter how much N is applied, there will not be a commensurate increase in yield. In this situation, the factor k may be assigned a value of 0.25 in order to conserve N in this part of the field. The purpose of the zone factor is to either increase or decrease the overall rate amount to account for landscape variability in the field due to soil types, topology, soil chemistry, drainage, organic matter, etc. This zone factor is typically utilized when additional geospatial information (for example soil maps, yield maps, biomass maps, soil sample) are incorporated into the variable rate system to account for highly productive or nonproductive regions of the field. When the VRA system is operated in real-time and not utilizing other geospatial data, the zone factor is ignored by setting its value equal to 1.0. Zone factor k can also be determined in real-time through the use of a soil sensor. This soil sensor can be either a conductivity sensor that is pulled through or over the soil, optical in situ soil sensor or a reflectance sensor such as disclosed in U.S. Pat. No. 7,408,145, herein incorporated by reference. Measurements collected by these sensors can be utilized in conjunction with a look-up table or equation to generate values for the zone coefficient k. Furthermore, zone factor k can also be split into zone factors k1 and k2 where k1 modifies only S_{App} and k2 modifies G·ƒ(α). This gives the application rate method additional flexibility in situations when either the grower application rate or the sensor application rate is to modified or shut down independently with respect to the other.

Additionally, α may be further defined as:

$$α = \frac{{VI}_{Field} - {VI}_{Ref}}{{VI}_{Max} - {VI}_{Min}} \qquad ( 2 )$$

Where VI_{Field} is the real-time vegetation index information measured via remote sensing,
VI_{Ref} is a statistical measure of the crop canopy which may include plug value, maximum, minimum, average, etc. . . . vegetation index values,
VI_{Max} is the maximum value of the vegetation index of the scanned field, and
VI_{Min} is the minimum value of the vegetation index of the scanned field.

The function variable α is utilized by the method presented in this work to characterize the crop variability and to control the range (bound) of numeric values that the sensed crop data will assume for rate processing. This method essentially reduces the system's sensitivity to absolute sensor calibrations via normalization. The use of ratios, differences or combinations of both when defining α will greatly reduce errors associated with sensor drift and offset. Other methods of defining α are discussed in patent applications such as may be described in U.S. patent application Ser. No. 13/248,523, filed Sep. 9, 29, 2011; U.S. patent application Ser. No. 12/815,721, filed Jun. 15, 2010; U.S. Pat. No. 7,723,660; U.S. Pat. No. 8,319,165, all of which are hereby incorporated by reference in their entireties. It will apparent to one skilled in the art that there a numerous ways to define α, so as to result in a normalized function variable which will result in normalization of growth response function ƒ, without deviating from the scope of this invention.

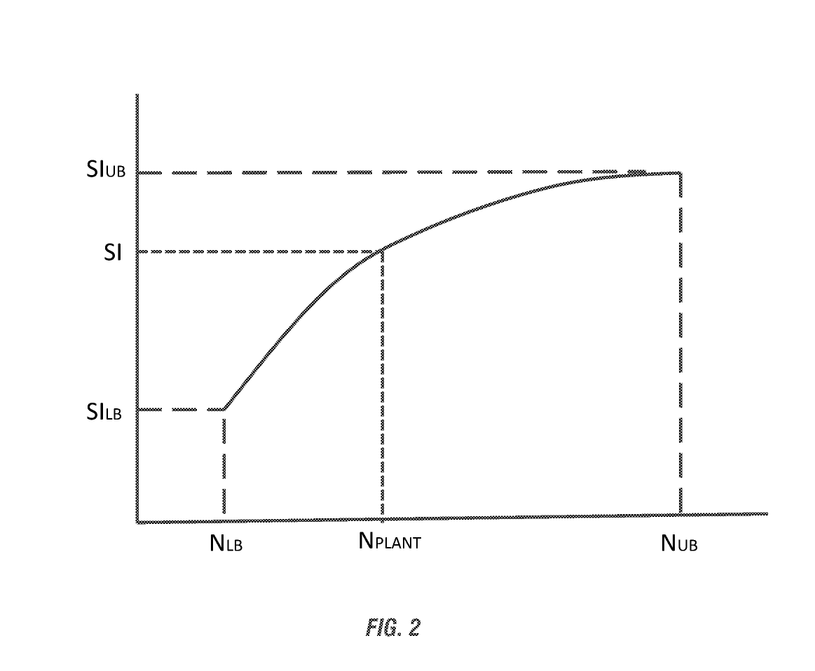

Furthermore, growth function ƒ(α) may be defined to provide the applicator system with a customized response to changing vegetation biomass or crop stress. The function may be tailored so as to model the growth behavior of the plant in general or at a specific time in its growth cycle. For example, ƒ(α) may simply be the variable α times a scale constant G, a piecewise continuous (or discontinuous) function, a look up table, or other curvilinear function (polynomial, sigmoid, etc.). In the case of a scale constant G, the variable α is related to an agrochemical rate proportional to changes in crop biomass. Also, ƒ(α) might also be a generalized plant growth response function. This function can be manipulated so that the terms of the function are parameterized in terms of optimum nitrogen use and sensor values. Furthermore, the shape of this growth response function can be modified so as to best utilize the plants the plant's genetic characteristics and/or the fertility of the soil in which the plant is growing. Methods to do so include splines, piecewise curve fitting, weighted functions, etc.; however, it will be apparent to those skilled in the art that there are many functional forms that can utilized to manipulate a plant's growth response function. For example, assume the shape of the generalized growth response curve in FIG. 2 can be described using a power-of-γ proportionality and can be stated mathematically as

SI=c·[N]^{γ} (3)

where SI is the sufficiency index defined as

$$SI = \frac{{VI}_{FIELD}}{{VI}_{REF}} ,$$

c is a constant of proportionality,

N is the nutrient growth response function of the plant, and

γ is the growth response power coefficient.

Assuming the growth response function relating sensor values to available nutrient for a plant has the proportional mathematical form,

$$\frac{{SI}_{UB} - SI}{{S}_{UB} - {SI}_{LB}} = c \cdot {[ \frac{{N}_{UB} - {N}_{PLANT}}{{N}_{UB} - {N}_{LB}} ]}^{γ} \qquad ( 4 )$$

where SI is the sufficiency index defined as

$$SI = \frac{{VI}_{FIELD}}{{VI}_{REF}} ,$$

SI_{UB} is the upper bound for the sufficiency index,

SI_{UL} is the lower bound for the sufficiency index,

c is a constant of proportionality,

N_{UB} is the upper bound for useable or available nitrogen (N),

N_{UL} is the lower bound for useable or available nitrogen (N),

N_{PLANT} is the nitrogen (N) in the plant, and

γ is the growth response power coefficient.

Simplifying the above equation using the expressions for ΔSI and ΔN below in eq. 5,

ΔSI=SI_{UB}−SI_{LB} and ΔN=N_{UB}−N_{LB} (5)

and solving of for N in eq. 4, we obtain the following expression for the nitrogen (N) contained in the plant:

$${N}_{PLANT} = {N}_{UB} - Δ N \cdot {( \frac{{SI}_{UB} - SI}{c \cdot Δ SI} )}^{\frac{1}{γ}} \qquad ( 6 )$$

Now, if N_{UB}=N_{OPT}, SI_{UB}=1.0 and N_{LB}=0 is substituted in eq. 6 above, then

$${N}_{PLANT} = {N}_{OPT} - {N}_{OPT} \cdot {( \frac{1 - SI}{c \cdot Δ SI} )}^{\frac{1}{γ}} \qquad ( 7 )$$

The above equation for plant nitrogen uptake (growth response) can be utilized with the variable rate control equation for variable dispensing fertilizer to a plant or crop. The control equation is

N_{APP}=N_{OPT}−N_{PLANT} (8)

where N_{APP} is the nitrogen application rate applied to the plant,

N_{OPT} is the agronomic or economic optimal N rate to achieve optimal yield, and

N_{PLANT} is the nitrogen taken up by the plant at the time N application.

Substituting eq. 7 for N_{PLANT} into eq. 8 we obtain

$$\begin{matrix}{N}_{APP} = {N}_{OPT} - {N}_{PLANT} \\ = {N}_{OPT} - ( {N}_{OPT} - {N}_{OPT} \cdot {( \frac{{SI}_{UB} - SI}{c \cdot Δ SI} )}^{\frac{1}{γ}} ) \\ = {N}_{OPT} \cdot {( \frac{{SI}_{UB} - SI}{c \cdot Δ SI} )}^{\frac{1}{γ}}\end{matrix} \qquad ( 9 )$$

where N_{OPT} is the agronomic or economic optimal N rate to achieve optimal yield,

SI is the sensor sufficiency index,

SI_{UB} is the upper bound for the sufficiency index,

ΔSI is the sufficiency index difference between SI_{UB} and SU_{LB}

It should be noted that the quadratic N-rate growth response model developed by

Holland and described in Holland and Schepers, “Derivation of a variable rate nitrogen application model for in-season fertilization of corn”, Agronomy Journal 102: 1415-1424, is the special case of eq. 9 when γ is equal to 2 and c=1.0. N_{OPT} in eq. 9 can further be expanded to include a number of other site specific and crop specific parameters. These parameters might include, but not limited to, optimal N rate, pre plant N rate, climate information, supplemental N sources, genetics, soil fertility, water, etc. A modified form of N_{OPT} is shown in eq. 10 below.

N′_{OPT}=N_{OPT}−ΣN_{CREDIT}−N_{CLIMATE}+ΣN_{SUPPLEMENT}∓N_{GENETIC}=N_{MANAGE} (10)

where N_{OPT} is the agronomic or economic optimal N rate to achieve optimal yield,
ΣN_{CREDIT} is the sum of nitrogen credits resulting from previous cropping history, manure application, pre-plant N application, N content in irrigation water, etc.,
N_{CLIMATE} is N mineralization due to climate conditions at the time N application,
ΣN_{SUPPLEMENT} is the sum of additional N supplements needed resulting from N loss pathways during the cropping season, for example, leaching, run off, denitrification, soil microbial competition, post anthesis, etc.,
N_{GENETIC} is the N credit or supplement as determined by the crop's genetic traits and
N_{MANAGE} is the N rate that the sensor based N application system will apply based on the crop's nutrient needs as determined by sensor measurements.

As alluded to above in eq. 10, N_{MANAGE} can be further refined to support genetic specific nitrogen use efficiencies for a crop. The concept can be expanded to include multiple crop hybrids or varieties planted within a single field. N_{MANAGE}, shown in eq. 11, is depicted to be a member of a set of nutrient recommendations based on the genetic qualities of various hybrids.

N_{MANAGE}ε{N_{MANAGE}^{Hybrid 1},N_{MANAGE}^{Hybrid 2}, . . . ,N_{MANAGE}^{Hybrid n}} (11)

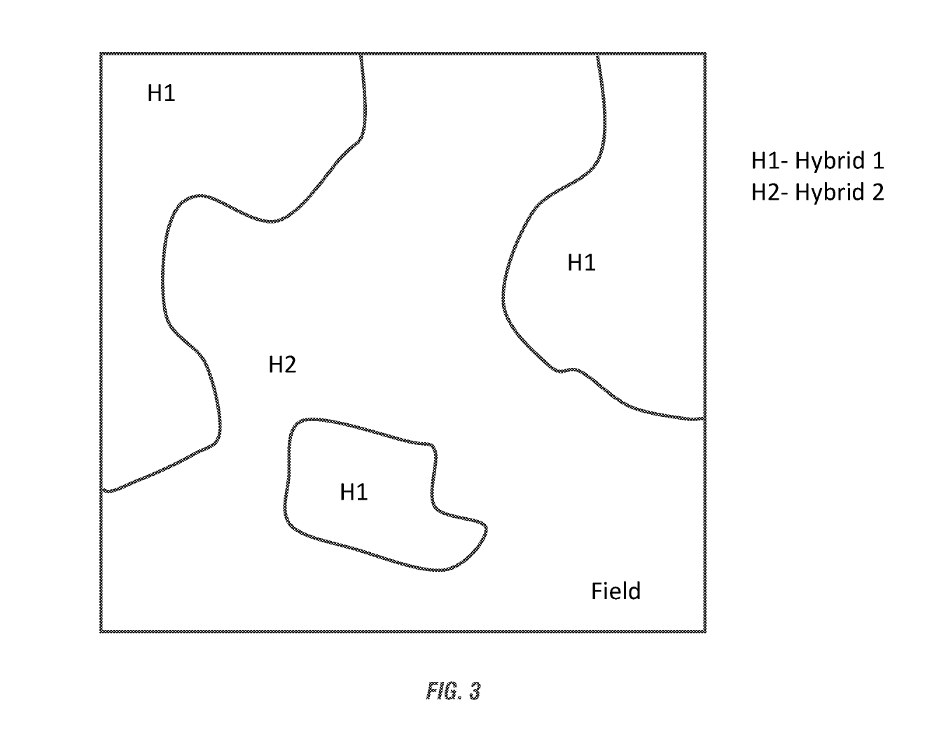

The unique genetic traits of a given hybrid or variety may be particularly suited for growing in low organic matter soil or soil with low water holding capacity. For example, hybrid 1 may have optimal nitrogen or nutrient requirements for one soil type or landscape topography that are sandy, low organic, sloping landscape, etc. . . . whereas hybrid 2 may perform better on soil types or landscape topographies different from the previous soil type in that it has higher organic matter content, high water holding capacity, level landscape, etc. By using more than one hybrid in the field, overall yield for the field can be maximized by taking advantage of each hybrid's or varieties specific genetic traits for different moisture and soil fertility conditions in the field. To fully exploit the genetic performance of each hybrid, it is necessary to have a nutrient application system that properly delivers crop nutrients both spatially and temporally. A real-time sensor-based applicator such as described here does this. In order to incorporate spatial information pertaining to various hybrid locations in the field, a seed planting map may, for example, be utilized variable rate applicator system's controller. Further, the methods detailed patent applications such as may be described in U.S. patent application Ser. No. 13/248,523, filed Sep. 9, 29, 2011; U.S. patent application Ser. No. 12/815,721, filed Jun. 15, 2010; U.S. Pat. No. 7,723,660; U.S. Pat. No. 8,319,165, all of which are incorporated herein by reference, can be used to create multiple calibrations for each hybrid's growth response function. For example, planting zone 1 (PZ₁) may be associated with hybrid 1 whereas planting zone 2 (PZ₂) is associated with hybrid 2. Associated with each hybrid may be hybrid dependent plug values as well as real-time statistical information collected for each hybrid independent of one another. For example, the control system would collect data relating to hybrid 1 and generate an associated histogram (or other statistical information) for calibration/analysis whereas the control system would also collect data relating to hybrid 2 and generate an associated histogram (or other statistical information) for calibration purposes/analysis. FIG. 3 shows a field planted with 2 hybrids. The VRA control system creates histograms for each hybrid using a seed planting map to partition real-time collected data from the sensors. Each hybrid could also have its own predetermined plug value as determined by the seed producer, such as for example by Pioneer Hybrid, Monsanto, Syngenta, etc. Additionally, the growth response function can be further manipulated to exploit the expression of various genes when the plant is exposed to various levels of in-situ nutrient (NO3 or NH4) For instance, certain nutrient transport channels in the plants rhizome cells will express themselves at high or low levels of soil N. In this, case it may be advantageous to preferentially apply either NO3 or NH4 are a mixture having a particular NH4 to NO3 ratio that would be more readily absorbed by the plant. Furthermore, it could be that applying a micronutrient that may be limiting at high SI values (0.9 to 1.0) could help boost yields, e.g., applying a solution composed of magnesium or other micronutrients may help boost yields. As such, the VRA applicator may have specialized flow control equipment to maximize yield, such as disclosed in patent application Ser. No. 13/633,249, herein incorporated by reference, that can adjust the agrochemical composition to match the plants nutrient needs and/or modifying the growth response function to match the plants nutrient use efficiency. Sensing of crop attributes via aerial, proximal or satellite sensors (optical or other electromagnetic type) can be utilized in conjunction with crop growth response function to determine the crop's optimal growth performance mode. This mode may be modified via the use of specialize agrochemicals that can switch ON or OFF various engineered genetic traits that would help the plant thrive under a given type of climate or landscape regime. For example a specific trait may be switched ON via a specialized agrochemical if the season's climate trends toward draught conditions. In this case, the producer would purchase the needed chemical to activate the trait from his seed dealer. Or, if a particular pest is particularly prevalent during a growing season, the trait could be turned ON to help the crop thrive. This mode is particularly useful when concerns regarding developed treatment resistance by the pest can occur over years of exposure to an agrochemical or genetic trait, e.g., glyphosate or bacillus thuringiensis trait (BT), respectively. Examples of genetic traits include agrochemical or herbicide resistance traits such as a glyphosate tolerance trait or a glufosinate tolerance trait. Examples of genetic traits further include insecticide resistance traits such as resistance to rootworm, resistance to insects such as European corn borer, Southwestern corn borer, western bean cutworm, fall armyworm, corn earworm, and black cutworm, or other types of insects. With regard to the BT trait, this may be beneficial to the environment in that the trait would not be activated until the plant needed resistance to the pest. This would help preserve beneficial insects that might be adversely affected by wide spread expression of the trait throughout the growing season. Use of sensing technology (aerial, proximal or satellite) may be utilized to site specifically to aid in application of trait expression agrochemicals to selectively create refuge areas of the field, controlled infestation regions, etc. Changes in biomass or pigment content may be sensed and the growth response model utilized to determine changes in growth performance trends. Hence, the model may be utilized to spatially control the trait expressing agrochemical application rate based on the genetic characteristics of the plant.

Another unique aspect of the methodology presented above pertains to its flexibility of use. For example, one embodiment may embed these equations and associated calibration methodology in a control module that connects to an agricultural system controller. This way, various components of the models and associated trade secrets (genetics, calibration constants, etc.) can be protected from distribution to the public while offering a completive market advantage to the technology manufacturer. Another method use would be to embed the various components of the models and associated trade secrets into the sensor itself. The usefulness of this is that it would minimize computation and data transfer overhead on the system controller and controller communication bus (CAN, RS485, Ethernet, wireless, etc.) while at the same time protecting the manufacturer/s intellectual property. Yet, another would be to embed this information into the system controller. In this embodiment, data from the sensor system would be collected via the controller's communication bus and analyzed using the various components of the models and associated trade secrets of this method. Another embodiment may encode the model, crop and region specific information in the barcode printed on the bag of seed or agrochemical container.

Referring back to the sensor embodiment, the sensor itself may include additional sensing electronics internally or with other external sensors to further trim and refine the shape of the nutrient or agrochemical generalized growth response model. These sensors could include but not limited to inclinometers (tilt sensors), infrared thermometers, humidity sensors, geospatial sensors (GPS), soil sensor sensors, organic matter sensors, optical image sensors, height sensors, etc. For example, the sensor could contain an internal inclinometer or tilt sensor. The information from the inclinometer or tilt sensor could be utilized to increase agrochemical application rates at the top of hills or on the side of hills where early applied agrochemical (nutrient, pesticide, herbicide, etc.) may have run-off. Furthermore, agrochemical application may be reduced at the bottom (valleys) where there may be higher concentration of organic matter or accumulation of early applied agrochemicals. External sensors can be queried for ancillary information or configured to broadcast information periodically over the communication bus. This information can be used to further refine the overall performance of a treated crop by modifying the shape of the growth model.

The embodiments presented above can be equally or preferentially applied to proximal (ground-based), satellite or aerial sensing either for real-time agrochemical application or application after post processing collected data.

### Identifying Hybrid or Variety

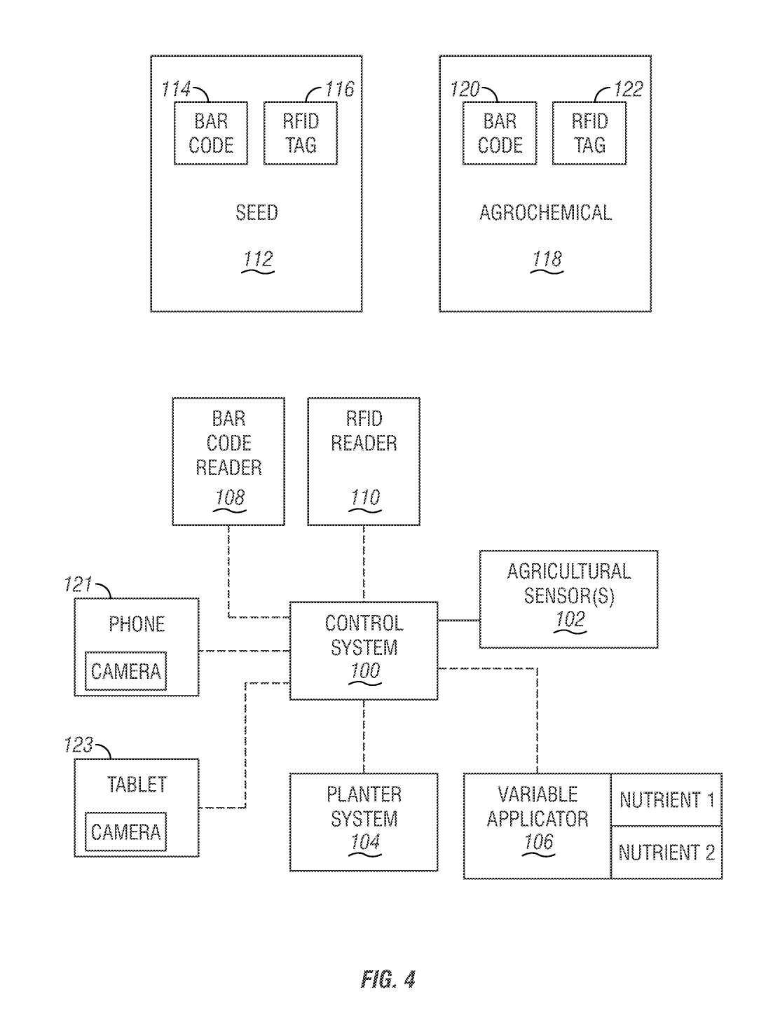

As shown in FIG. 4 bar code or RFID information associated with seed in a seed container (such as a seed bag or bulk container) may be used to provide information regarding genetic identity or traits of a particular hybrid or variety. In FIG. 4, a control system 100 is shown which is operatively connected to one or more agricultural sensors 102. The control system 100 is also operatively connected to a system for applying agricultural products such as a planter system 104 or a variable applicator 106. The variable applicator 106 may be used to apply a nutrient at a primary nutrient rate and/or a nutrient boost rate. The control system 100 is also in operative communication with a bar code reader 108 or RFID reader 110. Additionally, the reader could be a smart phone or tablet computer with a dedicated software application to read information from a seed bag or other agricultural product (with information encoded as barcode or other encoding scheme) via its integrated camera and transmit this information to the control system via wireless communication. For example, as shown in FIG. 4, a phone 121 may include a camera and the phone 121 may be configured to use the camera to acquire an image of a barcode and decode it. The phone 121 may be further configured to convey information obtained from the barcode to the control system 100 such as through a BLUETOOTH link or via Wi-Fi, NFC, or through another type of communications channel. Similarly, a tablet computer 123 may include a camera and the tablet computer 123 may be configured to use the camera to acquire an image of a barcode and decode it. The tablet computer 123 may be further configured to convey information to the control system 100 such as through a wireless communications link. It is also contemplated that information derived from a barcode or RFID tag or other type of tag may be displayed on the phone 121 or tablet 123 and then manually input into the control system 100 by the user. A container such as a bag of seed 112 is shown which may include a bar code 114 and/or an RFID tag 116. The bar code can be a one- or two-dimensional bar code. Similarly, a container of agrochemical 118 may also include a bar code 120 and/or an RFID tag 122. The bar codes may be read by the bar code reader 108 and information obtained therefrom may then be communicated to the control system 100 either manually or automatically. Similarly, the RFID tags may be read by the RFID reader 110 and information obtained therefrom may then be communicated to the control system 100. Thus, genetic information may be communicated in this manner. Alternatively, such information may be manually input by a user from the seed container or otherwise. Thus, the type of variety or hybrid and other genetic information may be received by scanning information associated with the container of seed, wirelessly reading information associated with the container of seed, or receiving user input based on data provided by the container of seed.

### Applying Multiple Nutrients

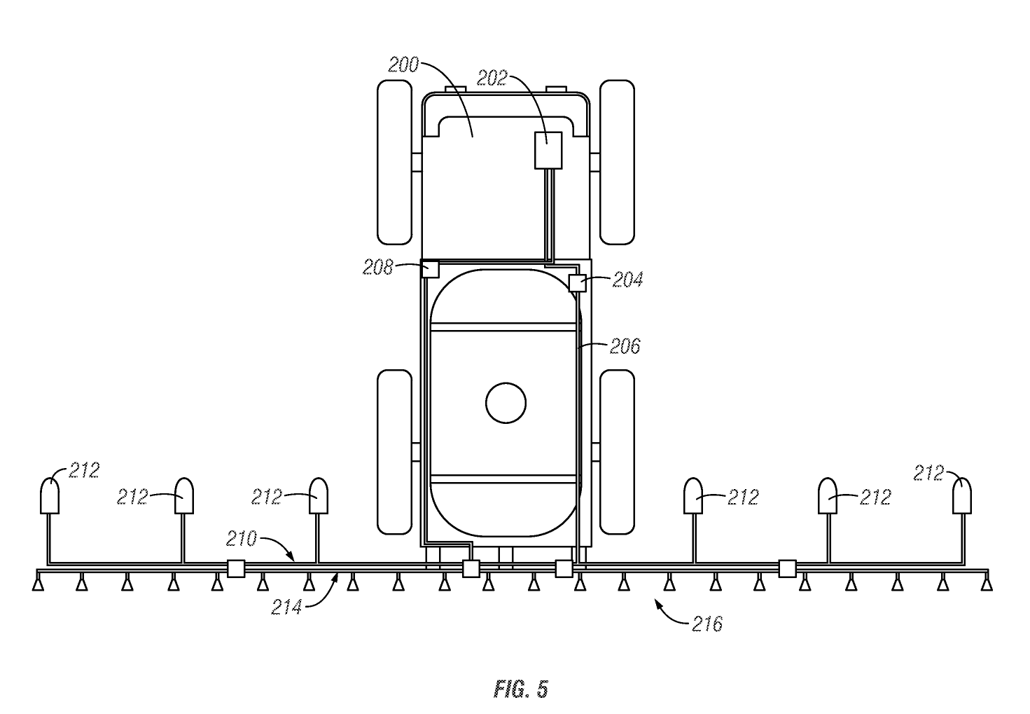

As shown in FIG. 5 a vehicle 200 is shown with a vehicle controller 202 on the vehicle 200. A sensor electronic control unit 204 is operatively connected to a bus network 206 as is the vehicle controller 202. A flow control electronic control unit or controller 208 is operatively connected to the vehicle controller 202 which may be used to provide for variable application rates of a nutrient. A plurality of real-time sensor(s) 212 are connected along a boom of the vehicle 200. As shown in FIG. 5, a dispensing system 216 may include both a first nutrient flow system 210 and a second nutrient flow system 214. In such a system, the primary nutrient flow system may be used for dispensing a nutrient according to a first nutrient application rate and the second nutrient flow system may be used for dispensing the nutrients according to a second nutrient flow rate. The dispensing system may provide for applying one or the other or a mix of both nutrients at the same time.

### Options, Alternatives, and Variations

Various examples of the methods, apparatus, and systems of the present invention have been described. It is to be understood that the present invention contemplates numerous options, variations, and alternatives. In addition, it is to be understood that the present invention contemplates any number of different combinations of features which have been described even if such features are from different embodiments, as such combinations may be more suitable for a particular application, environment, or use.

What is claimed is:

1. A method for applying agrochemicals within a geographical area, the method comprising:
determining identify of a first hybrid or variety within the geographical area;
determining identify of a second hybrid or variety within the geographical area;
applying agrochemicals to the geographical area using a variable rate controller based on the identity of the first hybrid or variety and the identity of the second hybrid or variety and wherein the variable rate controller is configured to apply the agrochemicals using a first model for the first hybrid or variety within the geographical area and a second model for the second hybrid or variety within the geographical area.

2. The method of claim 1 wherein the variable rate controller is further configured to use for initial calibration a first growth stage appropriate plug value for the first hybrid or variety within the geographical area and a second growth stage appropriate plug value for the second hybrid or variety within the geographical area.

3. The method of claim 1 wherein the variable rate controller is further configured to parameterize the first model for the first hybrid or variety and the second model for the second hybrid or variety with plant growth parameters.

4. The method of claim 3 wherein the plant growth parameters are obtained using one or more sensors.

5. The method of claim 4 wherein the one or more sensors are optical sensors.

6. The method of claim 3 wherein the plant growth parameters are obtained from aerial imaging.

7. The method of claim 3 wherein the plant growth parameters are obtained from satellite imaging.

8. The method of claim 1 wherein the agrochemical activates expression of a genetic trait.

9. The method of claim 1 wherein the agrochemical suppresses expression of a genetic trait.

10. A method for applying agrochemicals within a geographical area, the method comprising:
maintaining a first vegetative index using a variable rate controller, the first vegetative index associated with a first plant type;
maintaining a second vegetative index using the variable rate controller, the second vegetative index associated with a second plant type;
applying the agrochemicals to the geographical area using the variable rate controller, wherein the variable rate controller uses the first vegetative index in determining application rates for the first plant type and the second vegetative index in determining application rates for the second plant type.

11. The method of claim 10 wherein the first plant type is a type of hybrid.

12. The method of claim 10 wherein the first plant type is variety.

13. The method of claim 10 further comprising sensing plant growth parameters using an optical sensor and using the plant growth parameters in the first vegetative index.

14. The method of claim 10 further comprising sensing plant growth parameters using an optical sensor and using the plant growth parameters in the second vegetative index.

15. The method of claim 10 further comprising sensing the plant growth parameters using satellite imaging.

16. The method of claim 10 further comprising sensing the plant growth parameters using aerial imaging.

17. A method for applying agrochemicals within a geographical area, the method comprising:
acquiring a growth stage appropriate plug value for an initial calibration at least partially based on genetic information for a plant variety or plant hybrid;
using the growth state appropriate plug value in the initial calibration;
applying agrochemicals to the geographical area according to the initial calibration.

18. The method of claim 17 wherein the agrochemicals activate or suppress a genetic trait of the plant variety or plant hybrid.

19. The method of claim 17 further comprising acquiring a plant growth parameter for the plant variety or the plant hybrid from sensor data.

20. The method of claim 19 further comprising using the plant growth parameter in a plant growth response function and adjusting application for the agrochemicals based on a model comprising the plant growth response function.

21. The method of claim 20 wherein the sensor data is acquired using a ground-based optical sensor.

22. The method of claim 20 wherein the sensor data is associated with satellite imagery.

23. The method of claim 20 wherein the sensor data is associated with aerial imagery.
